(19) United States
(12) Patent Application Publication
(10) Pub. No.: US 2023/0328472 A1
(43) Pub. Date: Oct. 12, 2023

(54) METHOD OF RENDERING OBJECT-BASED AUDIO AND ELECTRONIC DEVICE FOR PERFORMING THE SAME

(71) Applicant: Electronics and Telecommunications Research Institute, Daejeon (KR)

(72) Inventors: Yong Ju LEE, Daejeon (KR); Jae-hyoun YOO, Daejeon (KR); Dae Young JANG, Daejeon (KR); Kyeongok KANG, Daejeon (KR); Soo Young PARK, Daejeon (KR); Tae Jin LEE, Daejeon (KR); Young Ho JEONG, Daejeon (KR)

(73) Assignee: Electronics and Telecommunications Research Institute, Daejeon (KR)

(21) Appl. No.: 18/120,193

(22) Filed: Mar. 10, 2023

(30) Foreign Application Priority Data
Mar. 28, 2022 (KR) 10-2022-0038074
Jul. 12, 2022 (KR) 10-2022-0085755
Dec. 6, 2022 (KR) 10-2022-0168793

(51) Int. Cl. H04S 7/00

(52) U.S. Cl. CPC H04S 7/302; H04S 2420/01; H04S 2420/11

(57) ABSTRACT

A method of rendering object audio and electronic device for performing the method are provided. The method includes identifying object audio and metadata including a reference distance of the object audio and an audio source distance between the object audio and a listener, identifying a maximum distance of the object audio determined based on the reference distance, when the audio source distance is less than or equal to the maximum distance, determining a gain of the object audio based on the audio source distance and the reference distance, and rendering the object audio according to the gain of the object audio.

### CROSS-REFERENCE TO RELATED APPLICATIONS

This application claims the benefit of Korean Patent Application No. 10-2022-0038074 filed on Mar. 28, 2022, Korean Patent Application No. 10-2022-0085755 filed on Jul. 12, 2022, and Korean Patent Application No. 10-2022-0168793 filed on Dec. 6, 2022, in the Korean Intellectual Property Office, the entire disclosures of which are incorporated herein by reference for all purposes.

### BACKGROUND

### 1. Field of the Invention

One or more embodiments relate to a method of rendering object audio and an electronic device for performing the method.

### 2. Description of the Related Art

Audio services have changed from mono and stereo services to 5.1 and 7.1 channels and to multi-channel services such as 9.1, 11.1, 10.2, 13.1, 15.1, and 22.2 channels that include upstream channels.

Unlike existing channel services, object-based audio service technology that regards one audio source as an object and stores/transmits/plays information related to the object audio such as an object audio signal and object audio location and size is also being developed.

The above description is information the inventor(s) acquired during the course of conceiving the present disclosure, or already possessed at the time, and is not necessarily art publicly known before the present application was filed.

### SUMMARY

Embodiments provide a method of rendering object audio and an electronic device that may reduce an amount of computations of a terminal in calculating and processing a volume of sound according to a distance between a listener and object audio in a virtual reality (VR) environment.

However, the technical aspects are not limited to the aspects above, and there may be other technical aspects.

According to an aspect, there is provided a method of rendering object audio including identifying object audio and metadata including a reference distance of the object audio and an audio source distance between the object audio and a listener, identifying a maximum distance of the object audio determined based on the reference distance, when the audio source distance is less than or equal to the maximum distance, determining a gain of the object audio based on the audio source distance and the reference distance, and rendering the object audio according to the gain of the object audio.

The maximum distance may be determined by a positive integer multiple of the reference distance.

The maximum distance may be determined considering a size of a delay buffer according to the audio source distance of the object audio.

The maximum distance may be determined as a distance at which a gain when the object audio is at the maximum distance is attenuated by a set threshold, compared to a gain when the object audio is at the reference distance.

The rendering of the object audio may include not rendering the object audio or rendering the object audio to prevent the object audio from being output, when the audio source distance exceeds the maximum distance.

According to an aspect, there is provided a method of rendering object audio including identifying object audio and metadata including a reference distance of the object audio and an audio source distance between the object audio and a listener, identifying a maximum distance of the object audio determined based on the reference distance, determining whether to render the object audio using the audio source distance and the maximum distance, determining a gain of the object audio using the audio source distance and the reference distance, based on whether the object audio is rendered, and rendering the object audio according to the gain of the object audio.

The maximum distance may be determined by a positive integer multiple of the reference distance.

The maximum distance may be determined considering a size of a delay buffer according to the audio source distance of the object audio.

The maximum distance may be determined as a distance at which a gain when the object audio is at the maximum distance is attenuated by a set threshold, compared to a gain when the object audio is at the reference distance.

The rendering of the object audio may include not rendering the object audio or rendering the object audio to prevent the object audio from being output, when the audio source distance exceeds the maximum distance.

According to an aspect, there is provided an electronic device including a processor, wherein the processor is configured to identify object audio and metadata including a reference distance of the object audio and an audio source distance between the object audio and a listener, identify a maximum distance of the object audio determined based on the reference distance, when the audio source distance is less than or equal to the maximum distance, determine a gain of the object audio based on the audio source distance and the reference distance, and render the object audio according to the gain of the object audio.

The maximum distance may be determined by a positive integer multiple of the reference distance.

The maximum distance may be determined considering a size of a delay buffer according to the audio source distance of the object audio.

The maximum distance may be determined as a distance at which a gain when the object audio is at the maximum distance is attenuated by a set threshold, compared to a gain when the object audio is at the reference distance.

The processor may be configured not to render the object audio or render the object audio to prevent the object audio from being output, when the audio source distance exceeds the maximum distance.

Additional aspects of example embodiments will be set forth in part in the description which follows and, in part, will be apparent from the description, or may be learned by practice of the disclosure.

According to embodiments, the present disclosure has an advantage of reducing the amount of computations of a terminal for rendering object audio by providing a method in which object audio (hereinafter, the object audio may also be referred to as object-based audio) does not have to be rendered according to a distance between a listener and the object audio.

According to embodiments, since a maximum distance or a valid boundary distance of object audio is interlocked with characteristic information of the object audio, a content author may set the maximum distance and the valid boundary distance for each object audio and express characteristics of the object audio in more diverse ways.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a control workflow and a rendering workflow of an electronic device according to various embodiments;

FIG. 2 is a diagram illustrating a renderer pipeline according to various embodiments;

FIG. 3 is a block diagram illustrating an electronic device according to various embodiments;

FIG. 4 is a flowchart illustrating operations of a method of rendering object audio according to various embodiments;

FIGS. 5 and 6 are diagrams illustrating a maximum distance of object audio according to various embodiments;

FIG. 7 is a diagram illustrating a gain of object audio according to an audio source distance according to various embodiments; and

FIGS. 8A, 8B, and 8C are diagrams illustrating a gain of object audio based on a determined maximum distance according to various embodiments.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the example embodiments with reference to the accompanying drawings, like reference numerals refer to like elements and any repeated description related thereto will be omitted.

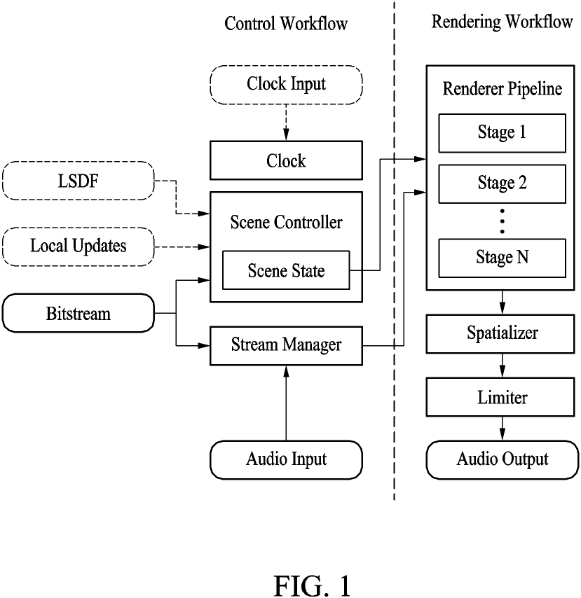

FIG. 1 is a diagram illustrating a control workflow and a rendering workflow of an electronic device 100 according to various embodiments.

According to an embodiment, the electronic device 100 may perform rendering of object audio 130 using a signal of the object audio 130 and metadata 140. For example, the electronic device 100 may refer to a renderer.

For example, the electronic device 100 may perform real-time audioization of an audio scene having 6 degrees of freedom (DoF) in which a user may directly interact with an entity of the audio scene. The electronic device 100 may perform rendering of virtual reality (VR) or augmented reality (AR) scenes. In the case of the VR or AR scenes, the electronic device 100 may obtain the metadata 140 and audio scene information from a bitstream. In the case of the AR scene, the electronic device 100 may obtain listening space information where a user is located from a listener space description format (LSDF) file.

As shown in FIG. 1, the electronic device 100 may output audio through a control workflow and a rendering workflow.

The control workflow is an entry point of the renderer and the electronic device 100 may interface with an external system and components through the control workflow. The electronic device 100 may adjust a state of entities of the 6-DoF scene and implement an interactive interface, using a scene controller in the control workflow.

The electronic device 100 may control a scene state. The scene state may reflect a current state of all scene objects including audio elements, transformations/anchors, and geometry. The electronic device 100 may generate all objects of the entire scene before the rendering starts and may update to a state in which a desired scene configuration is reflected in the metadata 140 of all objects when the playback starts.

The electronic device 100 may provide an integrated interface for renderer components to access an audio stream connected to an audio element of the scene state, using a stream manager. The audio stream may be input as a printed circuit board (PCB) float sample. A source of the audio stream may be, for example, a decoded moving picture experts group (MPEG-H) audio stream or locally captured audio.

A clock may provide the current scene time in seconds by providing the interface for the renderer components. A clock input may be, for example, a synchronization signal from another sub-system or an internal clock of the renderer.

The rendering workflow may generate an audio output signal. For example, the audio output signal may be a pulse code modulation (PCM) float. The rendering workflow may be separated from the control workflow. The stream manager to provide the scene state and an input audio stream to transmit all changes of the 6-DoF scene may access the rendering workflow for communication between the two workflows (the control workflow and the rendering workflow).

A renderer pipeline may audioize the input audio stream provided by the stream manager, based on the current scene state. For example, the rendering may be performed along a sequential pipeline, such that individual renderer stages implement independent perceptual effects and use processing of previous and subsequent stages.

A spatializer may terminate the renderer pipeline and audioize an output of the renderer stage into a single output audio stream suitable for a desired playback method (e.g., binaural or loudspeaker playback).

A limiter may provide a clipping protection function for the audioized output signal.

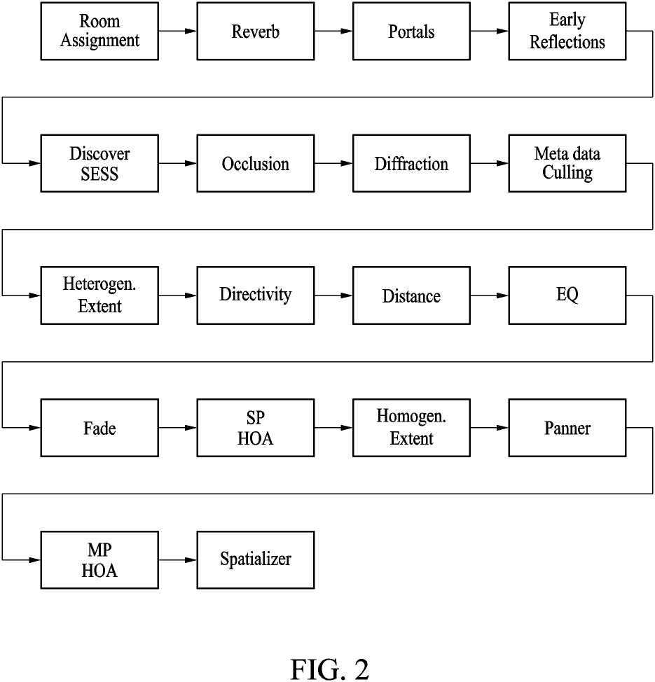

FIG. 2 is a diagram illustrating the renderer pipeline according to various embodiments.

For example, each renderer stage of the renderer pipeline may be performed according to a set order. For example, the renderer pipeline may include stages of room assignment, reverb, portal, early reflection, discover spatially extended sound source (SESS), occlusion, diffraction, culling of the metadata 140, heterogeny. extent, directivity, distance, equalizer (EQ), fade, single point higher-order ambisonics (SP HOA), homogen. extent, panner, and multi point higher-order ambisonics (MP HOA).

For example, the electronic device 100 may render a gain, propagation delay, and medium absorption of the object audio 130, according to the distance between the object audio 130 and the listener in the rendering workflow (e.g., the rendering workflow of FIG. 1). For example, the electronic device 100 may determine at least one of the gain, propagation delay, and medium absorption of the object audio 130, in the distance stage of the renderer pipeline.

In the distance stage, the electronic device 100 may calculate a distance between each render item (RI) and the listener and may interpolate a distance between update routine calls of the object audio 130 stream based on a constant velocity model. The RI may refer to all audio elements in the renderer pipeline.

The electronic device 100 may apply the propagation delay to a signal related to the RI to generate a physically accurate delay and Doppler effect.

The electronic device 100 may model a frequency-independent attenuation of the audio element due to geometric diffusion of source energy, applying a distance attenuation. The electronic device 100 may use a model considering the size of the audio source for the distance attenuation of a geometrically extended audio source.

The electronic device 100 may apply the medium absorption to the object audio 130, modeling the frequency-dependent attenuation of the audio element related to absorption characteristics of air.

The electronic device 100 may determine a gain of the object audio 130 by applying the distance attenuation according to the distance between the object audio 130 and the listener. The electronic device 100 may apply the distance attenuation due to the geometric diffusion, using a parametric model considering the size of the audio source.

When the audio is played in the 6-DoF environment, a sound level of the object audio 130 may vary depending on the distance, and the size of the object audio 130 may be determined according to the 1/r law in which the size decreases in inverse proportion to the distance. For example, the electronic device 100 may determine the size of the object audio 130 according to the 1/r law in a region where the distance between the object audio 130 and the listener is greater than a minimum distance and less than a maximum distance. The minimum distance and the maximum distance may refer to distances set to apply the attenuation, propagation delay, and air absorption effect according to the distance.

For example, the electronic device 100 may identify a location of the listener (e.g., three-dimensional (3D) spatial information), a location of the object audio 130 (e.g., the 3D spatial information), and the speed of the object audio 130, using the metadata 140. The electronic device 100 may calculate the distance between the object audio 130 and the listener, using the location of the listener and the location of the object audio 130.

The size of an audio signal transmitted to the listener may vary according to the distance between the audio source (e.g., the location of the object audio 130) and the listener. For example, in general, a sound level transmitted to the listener located at a distance of 2 meters (m) from the audio source may be less than the sound level transmitted to the listener located at a distance of 1 m from the audio source. In a free field environment, the sound level may be reduced by a ratio of 1/r (r is the distance between the object audio 130 and the listener). When the distance between the audio source and the listener is doubled, the sound level heard by the listener may be reduced by about 6 decibels (dB).

The law about the attenuation of the distance and sound level may be applied in the 6-Dof VR environment. The electronic device 100 may use a method of decreasing the size of one object audio 130 signal when the distance is far from the listener and increasing the size of one object audio 130 signal when the distance is close to the listener.

For example, assuming that a sound pressure level heard by the listener is 0 dB when the listener is 1 m away from the object audio 130, when the sound pressure level is changed to - 6 dB when the listener is 2 m away from the object audio 130, the listener may feel that the sound pressure naturally decreases.

For example, when the distance between the object audio 130 and the listener is greater than the minimum distance and less than the maximum distance, the electronic device 100 may determine a gain of the object audio 130 according to Equation 1 below. In Equation 1, the “reference_distance” may denote a reference distance and the “current distance” may denote the distance between the object audio 130 and the listener. The reference distance may refer to a distance at which the gain of the object audio 130 is 0 dB and may be set differently for each object audio 130. For example, the metadata 140 may include the reference distance of the object audio 130.

$$\text{Gain} \left[\text{dB}\right] = 20 log \left(r e f e r e n c e \_ d i s t a n c e / c u r r e n t \_ d i s t a n c e\right) \qquad \text{[Equation 1]}$$

For example, when the audio source distance is greater than or equal to the minimum distance and less than or equal to the maximum distance, the electronic device 100 may render the object audio 130 by determining the gain of the object audio 130 according to a distance attenuation model. When the audio source distance exceeds the maximum distance, the electronic device 100 may not render the object audio 130.

When the audio source distance of the object audio 130 exceeds the maximum distance, the electronic device 100 may reduce the amount of computations by not rendering the object audio 130.

The electronic device 100 may more appropriately determine whether to render each object audio 130 by determining the maximum distance based on the reference distance of the object audio 130.

For example, in the case of “mosquito sound,” the listener may not hear the sound when the audio source distance of the object audio 130 is 100 m, and in the case of “thunder sound.” the listener may hear the sound when the audio source distance is 600 m.

As described above, whether the object audio 130 is transmitted to the listener or whether the object audio 130 is audible/inaudible may be determined differently depending on the type of the object audio 130. In the above example, when the maximum distance of the object audio 130 is set to a constant value (e.g., 500 m), the object audio 130 of “mosquito sound” may be rendered, but the object audio 130 of “thunder sound” may not be rendered because the audio source distance exceeds the maximum distance.

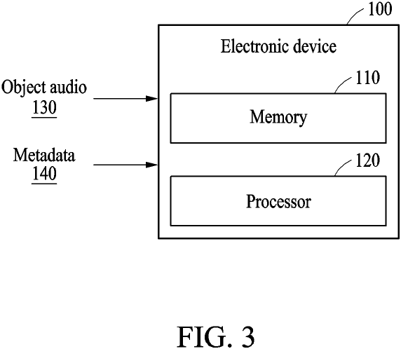

FIG. 3 is a block diagram illustrating the electronic device 100 according to various embodiments.

Referring to FIG. 3, the electronic device 100 may include a memory 110 and a processor 120 according to various embodiments.

The memory 110 may store various pieces of data used by at least one component (e.g., a processor or a sensor module) of the electronic device 100. The various pieces of data may include, for example, software (e.g., a program) and input data or output data for a command related thereto. The memory 110 may include volatile memory or non-volatile memory.

The processor 120 may execute, for example, software (e.g., a program) to control at least one other component (e.g., a hardware or software component) of the electronic device 100 connected to the processor 120, and may perform various data processing or computation. According to an embodiment, as at least a part of the data processing or computation, the processor 120 may store a command or data received from another component (e.g., a sensor module or a communication module) in a volatile memory, process the command or the data stored in the volatile memory, and store resulting data in a non-volatile memory. According to an embodiment, the processor 120 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently from, or in conjunction with the main processor. For example, when the electronic device 100 includes a main processor and an auxiliary processor, the auxiliary processor may be adapted to consume less power than the main processor or to be specific to a specified function. The auxiliary processor may be implemented separately from the main processor or as a part of the main processor.

Regarding operations described below, the electronic device 100 may perform the operations using the processor 120. For example, the electronic device 100 may identify the object audio 130 and the metadata 140 using the processor 120 and determine the gain of the object audio 130. In another example, the electronic device 100 may further include a separate module (not shown) or block (not shown) for determining the gain (or volume, volume level, sound level) of the object audio 130 according to the distance. For example, the electronic device 100 may further include a renderer (not shown) for rendering the object audio 130, and the renderer of the electronic device 100 may render the object audio 130 using the object audio 130 and the metadata 140.

The electronic device 100 may identify the object audio 130 and the metadata 140 of the object audio 130. The metadata 140 may include information related to the object audio 130. For example, the metadata 140 may include at least one of the 3D location information, volume information, reference distance information, minimum distance information, and maximum distance information of the object audio 130, or a combination thereof.

The reference distance may refer to the distance at which the gain of the object audio 130 is 0 dB and may refer to a reference for applying the attenuation according to the distance. The minimum distance and the maximum distance may refer to distances for applying the distance attenuation model. For example, when the audio source distance between the object audio 130 and the listener is greater than or equal to the minimum distance and less than or equal to the maximum distance, the electronic device 100 may determine the gain of the object audio 130 by applying the distance attenuation model (e.g., the distance attenuation according to Equation 1 and the distance attenuation according to the 1/r law).

The electronic device 100 may determine the maximum distance of the object audio 130 based on the reference distance. For example, the electronic device 100 may determine the maximum distance by multiplying the reference distance of the object audio 130 by a set positive integer. As shown in Equation 2 below, the electronic device 100 may determine the maximum distance by multiplying the reference_distance by a set integer M.

$$m a x i m u m \_ d i s t a n c e = r e f e r e n c e \_ d i s t a n c e \text{x} M \qquad \text{[Equation 2]}$$

Table 1 below represents a maximum distance (maximum distance by method 1) set to the same value (e.g., 500 m) in the object audio 130, a maximum distance (maximum distance by method 2) determined when M = “256” in Equation 2, and a maximum distance (maximum distance by method 3) determined when M = “512” in Equation 2.

TABLE 1

| | | | | | | | |
|---|---|---|---|---|---|---|---|
| Reference distance [m] of object | 1 | 2 | 5 | 10 | 20 | 50 | 100 |
| Maximum distance [m] by method 1 (500 m) | 500 | 500 | 500 | 500 | 500 | 500 | 500 |
| Maximum distance [m] by method 2 (where M is set to 256) | 256 | 512 | 1,280 | 2,560 | 5,120 | 12,800 | 25,600 |
| Maximum distance [m] by method 3 (where M is set to 512) | 512 | 1,024 | 2,560 | 5,120 | 10,240 | 25,600 | 51,200 |

For example, the electronic device 100 may determine the distance at which the gain of the object audio 130 is attenuated by a set threshold as the maximum distance, compared to a gain when the object audio 130 is at the reference distance.

For example, the electronic device 100 may determine a distance attenuated by - 60 dB, which is the set threshold, as the maximum distance rather than the gain of the object audio 130 at the reference distance. Referring to Equation 1, the electronic device 100 may determine a distance approximately 1,000 times larger than the reference distance as the reference distance considering the set threshold value of - 60 dB.

For example, the set threshold may be referred to as a sound attenuation valid threshold. The set threshold may be identically set for all object audio 130 but is not limited thereto, and may be set differently for each object audio 130. The threshold may be set differently for each object audio 130, for example, the threshold of a first object audio is -12 dB and the threshold of a second object audio is - 18 dB.

The maximum distance determined based on the reference distance may be understood as a valid boundary distance. The electronic device 100 may perform rendering of the object audio 130 in which the audio source distance is less than or equal to the maximum distance and may not perform rendering of the object audio 130 in which the audio source distance exceeds the maximum distance. The electronic device 100 may determine that the object audio 130 in which the audio source distance exceeds the maximum distance is inactive. The electronic device 100 may not render the object audio 130 in an inactive state.

For example, when the audio source distance exceeds a first maximum distance and is less than or equal to a second maximum distance, the electronic device 100 may determine the gain of the object audio 130 using the audio source distance. When the audio source distance exceeds the second maximum distance, the electronic device 100 may not render the object audio 130. For example, the gain of object audio 130 may linearly decrease from the first maximum distance to the second maximum distance to become “0”. For example, the first maximum distance may be referred to as a roll-off start distance and the second maximum distance may be referred to as a roll-off end distance. With respect to the object audio 130 in which the audio source distance exceeds the second maximum distance, the electronic device 100 may determine that the object audio 130 is inactive. The electronic device 100 may not render the object audio 130 in an inactive state.

The example in which the electronic device 100 sets the maximum distance of the object audio 130 is not limited to the above example, and the maximum distance of the object audio 130 may be set at a predetermined distance (e.g., 500 m, 1,000 m, etc.) or the maximum distance of the object audio 130 may be set at any value.

When the audio source distance of the object audio 130 is less than or equal to the valid boundary distance, the electronic device 100 may determine that the object audio 130 is valid, and when the audio source distance exceeds the valid boundary distance, the electronic device 100 may determine that the object audio 130 is invalid.

When the audio source distance is less than or equal to the maximum distance, the electronic device 100 may determine the gain of the object audio 130 based on the audio source distance and the reference distance. The electronic device 100 may determine the gain of the object audio 130 according to the distance attenuation model. For example, as shown in Equation 1, the electronic device 100 may determine the gain of the object audio 130 using the audio source distance and the reference distance.

For example, the electronic device 100 may determine the maximum distance considering the size of a delay buffer according to the distance of the object audio 130. For example, as the audio source distance of the object audio 130 increases, the propagation delay for transmitting the object audio 130 to the listener may increase. The size of the delay buffer may be determined considering the propagation delay when the object audio 130 is at the maximum distance.

Table 2 below represents, according to an embodiment, a buffer size and maximum delay time and a distance according to the buffer size.

TABLE 2

| Value | Buffer size (in samples) | Time period (second) | Distance (meter) |
|---|---|---|---|
| 0 | 10,000 | 0.21 | 70.8 |
| 1 | 20,000 | 0.42 | 141.7 |
| 2 | 30,000 | 0.63 | 212.5 |
| 3 | 50,000 | 1.04 | 354.2 |
| 4 | 100,000 | 2.08 | 708.3 |
| 5 | 200,000 | 4.17 | 1,416.7.00 |
| 6 | 500,000 | 10.42 | 3,541.7.00 |
| 7 | 1,000,000 | 20.83 | 7,083.3.00 |

As shown in Table 2, when the size of the delay buffer is “10,000”, it may be confirmed that the maximum delay time of the object audio 130 is 0.21 seconds (s) and the maximum distance of the object audio 130 is 70.8 m. For example, when the size of the delay buffer is “500,000”, the electronic device 100 may determine the maximum distance so that the maximum distance of the object audio 130 becomes 3,514.7 m or less. For example, the electronic device 100 may determine the threshold considering the size of the delay buffer.

The electronic device 100 may render the object audio 130 according to the gain of the object audio 130.

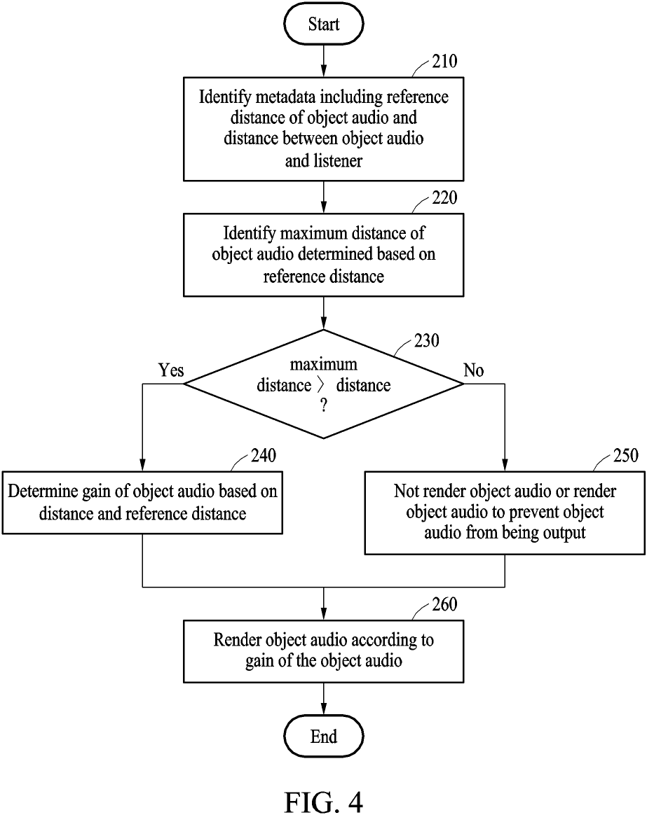

FIG. 4 is a flowchart illustrating operations of a method of rendering the object audio 130 according to various embodiments.

In operation 210, for example, the electronic device 100 may identify the metadata 140 including the reference distance of the object audio 130 and the distance between the object audio 130 and the listener. For example, the metadata 140 may include at least one of the 3D location information, volume information, reference distance information, minimum distance information, and maximum distance information of the object audio 130, or a combination thereof.

In operation 220, the electronic device 100 may identify the maximum distance of the object audio 130 determined based on the reference distance. For example, the electronic device 100 may determine a value obtained by multiplying the reference distance by the set positive integer as the maximum distance. When the reference distance of the object audio 130 is 1 m and the set integer is “512”, the electronic device 100 may determine the maximum distance of the object audio 130 as 512 m.

The electronic device 100 may determine a location at which the gain is attenuated by the set threshold as the maximum distance, compared to the gain when the object audio 130 is at the reference distance. For example, when the set threshold is - 60 dB, the electronic device 100 may determine the maximum distance of the object audio 130 in which the reference distance is 1 m as 1,000 m.

In operation 230, the electronic device 100 may compare the maximum distance to the audio source distance. The electronic device 100 may determine whether to render the object audio 130 using the audio source distance and the maximum distance. For example, when the maximum distance is greater than the audio source distance, the electronic device 100 may determine to render the object audio 130. When the maximum distance is less than or equal to the audio source distance, the electronic device 100 may determine not to render the object audio 130.

In operation 240, when the maximum distance exceeds the audio source distance, the electronic device 100 may determine the gain of the object audio 130 based on the audio source distance and the reference distance. For example, the electronic device 100 may determine the gain of the object audio 130 based on Equation 1.

In operation 250, when the maximum distance is less than or equal to the audio source distance, the electronic device 100 may not render the object audio 130 or render the object audio 130 to prevent the object audio 130 from being output. For example, the electronic device 100 may render the object audio 130 as an output signal corresponding to silence.

In operation 260, the electronic device 100 may render the object audio 130 according to the gain of the object audio 130. For example, the electronic device 100 may render the object audio 130 such that the size of the output audio signal corresponds to the gain of the object audio 130.

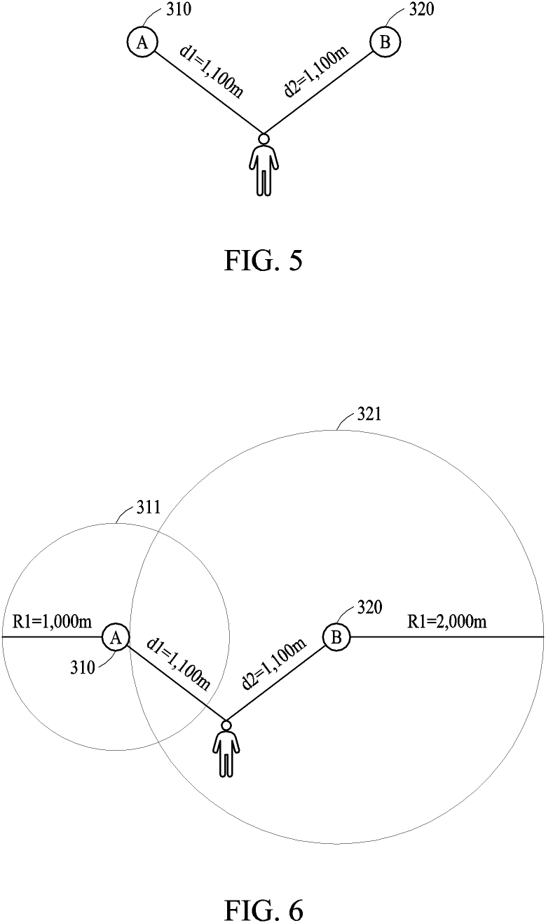

FIGS. 5 and 6 are diagrams illustrating the maximum distance of the object audio 130 according to various embodiments.

In FIGS. 5 and 6, object audio A 310 has the reference distance of 1 m and object audio B 320 has the reference distance of 2 m.

As shown in FIG. 5, the object audio A 310 and the object audio B 320 may be at the same audio source distance, respectively, (i.e., d1 = 1,100 m and d2 = 1,100 m) from the listener. The electronic device 100 may determine the maximum distance with respect to the object audio A 310 and the object audio B 320, based on the reference distance and the set threshold. The electronic device 100 may determine the maximum distance with respect to the object audio A 310 and the object audio B 320, based on the reference distance and the set integer.

For example, as shown in FIG. 6, when the set positive integer is “1,000”, the electronic device 100 may determine the maximum distance of the object audio A 310 as 1,000 m and the object audio B 320 as 2,000 m.

For example, as shown in FIG. 6, when the set threshold is - 60 dB, the electronic device 100 may determine the maximum distance of the object audio A 310 as 1,000 m and the maximum distance of the object audio B 320 as 2,000 m, based on Equation 1.

In FIG. 6, the electronic device 100 may determine the maximum distance of the object audio A 310, that is, the valid boundary distance of the object audio A 310, as 1,000 m, and the maximum distance of the object audio B 320, that is, the valid boundary distance of the object audio B 320, as 2,000 m.

The object audio A 310 and the object audio B 320 may be at the same audio source distance from the listener, but since the reference distances of the object audio A 310 and the object audio B 320 are different, the electronic device 100 may determine a different maximum distance or a valid boundary distance for each piece of object audio 130 (i.e., the object audio A 310 and the object audio B 320).

In FIGS. 5 and 6, since the audio source distance of the object audio A 310 exceeds the maximum distance, the electronic device 100 may not render the object audio A310 or render (e.g., silent processing) the object audio A 310 to prevent the object audio A 310 from being output.

In FIGS. 5 and 6, since the audio source distance of the object audio B 320 is less than or equal to the maximum distance, the electronic device 100 may determine a gain of the object audio B 320 according to the distance attenuation model. The electronic device 100 may render the object audio B 320 based on the determined gain of the object audio B 320.

As shown in FIGS. 5 and 6, by determining whether to render the object audio 130 using the maximum distance determined according to the reference distance of each object audio 130, the electronic device 100 may prevent an increase in the amount of computations due to the rendering of the object audio 130.

The electronic device 100 may render the object audio 130 suitable for the listener to listen and output the object audio 130 as the audio signal, by determining whether to render the object audio 130 according to the maximum distance determined based on the reference distance.

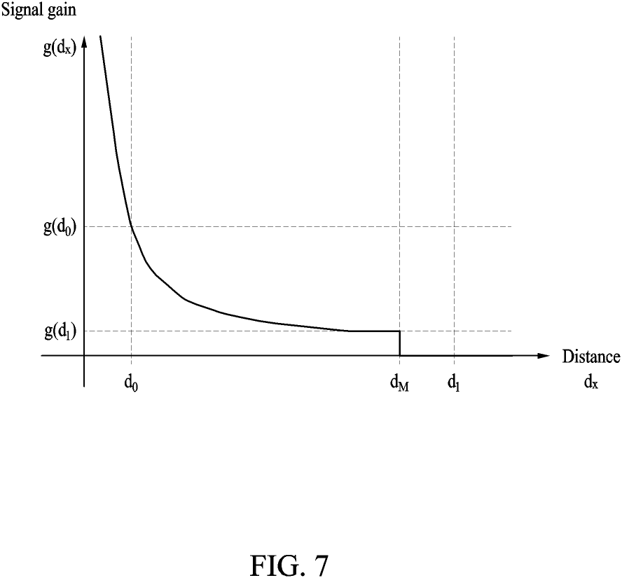

FIG. 7 is a diagram illustrating the gain of the object audio 130 according to the audio source distance according to various embodiments.

Referring to FIG. 7, the electronic device 100 may determine whether to render the object audio 130, based on the audio source distance and the maximum distance. In FIG. 7, when the audio source distance (e.g., distance dₓ) is greater than or equal to the maximum distance (e.g., d_{M}), the electronic device 100 may not render the object audio 130 or render the object audio 130 to prevent the object audio 130 from being output (e.g., silent processing). For example, the electronic device 100 may determine the gain (e.g., a signal gain) of the object audio 130 as “0”.

Referring to FIG. 7, when the audio source distance is less than or equal to the maximum distance, the electronic device 100 may determine the gain of the object audio 130. The electronic device 100 may determine the gain of the object audio 130 using Equation 1, according to the distance attenuation model. For example, when the audio source distance dₓ is less than d_{M}, the electronic device 100 may determine the gain of the object audio 130 as g(dₓ) = (d₀/dₓ) × g(d₀).

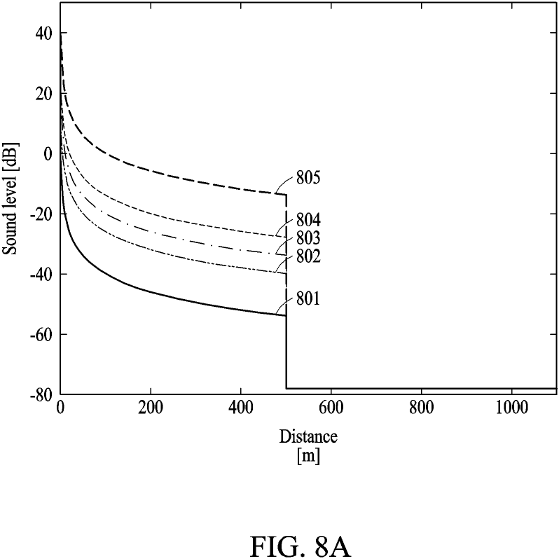

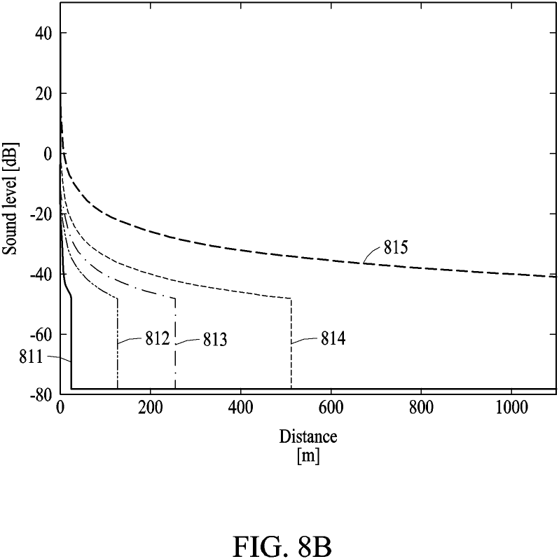

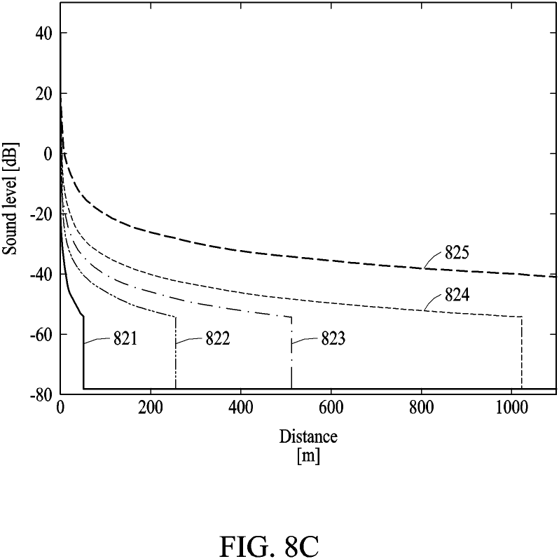

FIGS. 8A, 8B, and 8C are diagrams illustrating the gain of the object audio 130 based on the determined maximum distance according to various embodiments.

In FIGS. 8A, 8B, and 8C, graphs 801, 811, and 821 may represent the gain of the object audio 130 in which the reference distance is 1 m, graphs 802, 812, and 822 may represent the gain of the object audio 130 in which the reference distance is 5 m, graphs 803, 813, and 823 may represent the gain of the object audio 130 in which the reference distance is 10 m, graphs 804, 814, and 824 may represent the gain of the object audio 130 in which the reference distance is 20 m, and graphs 805, 815, and 825 may represent the gain of the object audio 130 in which the reference distance is 100 m.

FIG. 8A may represent the gain of the object audio 130 according to the audio source distance when the maximum distance of the object audio 130 is set to 500 m, FIG. 8B may represent the gain of the object audio 130 according to the audio source distance when the maximum distance of the object audio 130 is set to 256 times the reference distance (e.g., when M is “256” in Equation 2), and FIG. 8C may represent the gain of the object audio 130 according to the audio source distance when the maximum distance of the object audio 130 is set to 512 times the reference distance (e.g., when Mis “512” in Equation 2).

As shown in FIG. 8A, when the maximum distance of the object audio 130 is set to the same distance, regardless of the reference distance of the object audio 130, the electronic device 100 may determine the sound pressure level of the object audio 130 as about - 80 dB when the audio source distance exceeds the maximum distance.

In FIG. 8B, the electronic device 100 may determine the maximum distance of the object audio 130 according to the reference distance of each piece of object audio 130. For example, as shown in graph 811, with respect to the object audio 130 in which the reference distance is 1 m, the electronic device 100 may determine the sound pressure level of the object audio 130 as about - 80 dB when the audio source distance exceeds the maximum distance of 256 m. With respect to graphs 812, 813, 814, and 815, substantially the same as graph 811, the electronic device 100 may determine the sound pressure level of the object audio 130 as about - 80 dB when the audio source distances, respectively, exceed the maximum distances of 1,280 m, 2,560 m, 5,120 m, and 25,600 m.

In FIG. 8C, the electronic device 100 may determine the maximum distance of the object audio 130 according to the reference distance of each object audio 130. For example, as shown in graph 821, with respect to the object audio 130 in which the reference distance is 1 m, the electronic device 100 may determine the sound pressure level of the object audio 130 as about -80 dB when the audio source distance exceeds the maximum distance of 512 m. With respect to graphs 822, 823, 824, and 825, substantially the same as graph 821, the electronic device 100 may determine the sound pressure level of the object audio 130 as about - 80 dB when the audio source distances, respectively, exceed the maximum distances of 2,560 m, 5,120 m, 10,240 m, and 51,200 m.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The examples described herein may be implemented using hardware components, software components and/or combinations thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A method of rendering object audio, the method comprising:
identifying object audio and metadata comprising a reference distance of the object audio and an audio source distance between the object audio and a listener;
identifying a maximum distance of the object audio determined based on the reference distance;
when the audio source distance is less than or equal to the maximum distance, determining a gain of the object audio based on the audio source distance and the reference distance; and
rendering the object audio according to the gain of the object audio.

2. The method of claim 1, wherein the maximum distance is determined by a positive integer multiple of the reference distance.

3. The method of claim 1, wherein the maximum distance is determined considering a size of a delay buffer according to the audio source distance of the object audio.

4. The method of claim 1, wherein the maximum distance is determined as a distance at which a gain when the object audio is at the maximum distance is attenuated by a set threshold, compared to a gain when the object audio is at the reference distance.

5. The method of claim 1, wherein the rendering of the object audio comprises not rendering the object audio or rendering the object audio to prevent the object audio from being output, when the audio source distance exceeds the maximum distance.

6. A method of rendering object audio, the method comprising:
identifying object audio and metadata comprising a reference distance of the object audio and an audio source distance between the object audio and a listener;
identifying a maximum distance of the object audio determined based on the reference distance;
determining whether to render the object audio using the audio source distance and the maximum distance;
determining a gain of the object audio using the audio source distance and the reference distance, based on whether the object audio is rendered; and
rendering the object audio according to the gain of the object audio.

7. The method of claim 6, wherein the maximum distance is determined by a positive integer multiple of the reference distance.

8. The method of claim 6, wherein the maximum distance is determined considering a size of a delay buffer according to the audio source distance of the object audio.

9. The method of claim 6, wherein the maximum distance is determined as a distance at which a gain when the object audio is at the maximum distance is attenuated by a set threshold, compared to a gain when the object audio is at the reference distance.

10. The method of claim 6, wherein the rendering of the object audio comprises not rendering the object audio or rendering the object audio to prevent the object audio from being output, when the audio source distance exceeds the maximum distance.

11. An electronic device comprising:
a processor,
wherein the processor is configured to:
identify object audio and metadata comprising a reference distance of the object audio and an audio source distance between the object audio and a listener;
identify a maximum distance of the object audio determined based on the reference distance;
when the audio source distance is less than or equal to the maximum distance, determine a gain of the object audio based on the audio source distance and the reference distance; and
render the object audio according to the gain of the object audio.

12. The electronic device of claim 11, wherein the maximum distance is determined by a positive integer multiple of the reference distance.

13. The electronic device of claim 11, wherein the maximum distance is determined considering a size of a delay buffer according to the audio source distance of the object audio.

14. The electronic device of claim 11, wherein the maximum distance is determined as a distance at which a gain when the object audio is at the maximum distance is attenuated by a set threshold, compared to a gain when the object audio is at the reference distance.

15. The electronic device of claim 11, wherein the processor is configured to not render the object audio or render the object audio to prevent the object audio from being output, when the audio source distance exceeds the maximum distance.
